(19) United States
(12) Patent Application Publication
(10) Pub. No.: US 2018/0227504 A1
(43) Pub. Date: Aug. 9, 2018

(54) SWITCHABLE MULTIPLE VIDEO TRACK PLATFORM

(71) Applicant: Livestage Inc., New York, NY (US)

(72) Inventor: Kristopher King, Hermosa Beach, CA (US)

(73) Assignee: Livestage Inc., New York, NY (US)

(21) Appl. No.: 15/943,504

(22) Filed: Apr. 2, 2018

Related U.S. Application Data
(63) Continuation-in-part of application No. 14/941,582, filed on Nov. 14, 2015.
Application No. 14/941,582 is a continuation-in-part of application No. 14/719,636, filed on May 22, 2015.
Application No. 14/719,636 is a continuation-in-part of application No. 14/689,922, filed on Apr. 17, 2015, now abandoned.
Application No. 14/689,922 is a continuation-in-part of application No. 14/687,752, filed on Apr. 15, 2015, now abandoned.
Application No. 14/687,752 is a continuation-in-part of application No. 14/532,659, filed on Nov. 4, 2014, now abandoned.
Application No. 14/532,659 is a continuation-in-part of application No. 14/941,584, filed on Nov. 14, 2015.
Application No. 14/941,584 is a continuation-in-part of application No. 14/754,432, filed on Jun. 29, 2015.
Application No. 14/754,432 is a continuation-in-part of application No. 14/754,446, filed on Jun. 29, 2015.
Application No. 14/754,446 is a continuation-in-part of application No. 14/096,869, filed on Dec. 4, 2013, now abandoned.
(60) Provisional application No. 61/900,093, filed on Nov. 5, 2013.
(60) Provisional application No. 61/981,416, filed on Apr. 18, 2014.
(60) Provisional application No. 61/981,817, filed on Apr. 20, 2014.
(60) Provisional application No. 62/002,656, filed on May 23, 2014.
(60) Provisional application No. 62/080,386, filed on Nov. 16, 2014.
(60) Provisional application No. 62/080,381, filed on Nov. 16, 2014.
(60) Provisional application No. 62/018,853, filed on Jun. 30, 2014.
(60) Provisional application No. 62/019,017, filed on Jun. 30, 2014.

(51) Int. Cl. H04N 5/268; H04N 5/247; H04N 5/232; H04N 13/161; H04N 13/296; H04N 13/189; H04N 13/117

(52) U.S. Cl. CPC H04N 5/268; H04N 5/247; H04N 5/23238; H04N 2013/0096; H04N 13/296; H04N 13/189; H04N 13/117; H04N 13/161

(57) ABSTRACT

The present invention provides methods and apparatus for generating and transmitting a multimedia, multi-vantage point platform for viewing audio and video data. The present invention relates to methods and apparatus for providing a user switchable multiple video track platforms. More specifically, the present invention presents methods and apparatus for capturing multiple video streams of image data and video including 360° views and high definition (HD) image capture and transforming image and audio data into a viewing experience emulating observance of an event from multiple vantage points.

### FIELD OF THE INVENTION

The present invention relates to methods and apparatus for providing a user switchable multiple video track platforms. More specifically, the present invention presents methods and apparatus for capturing multiple video streams of image data and video including 360° views and high definition (HD) image capture and transforming image and audio data into a viewing experience emulating observance of an event from multiple vantage points.

### BACKGROUND OF THE INVENTION

Traditional methods of viewing image data generally include viewing a video stream of images in a sequential format. The viewer is presented with image data from a single vantage point at a time. Simple video includes streaming of imagery captured from a single image data capture device, such as a video camera. More sophisticated productions include sequential viewing of image data captured from more than one vantage point and may include viewing image data captured from more than one image data capture device.

As video capture has proliferated, popular video viewing forums, such as YouTube™, to allow for users to choose from a variety of video segments. In many cases, a single event will be captured on video by more than one user and each user will post a video segment on YouTube. Consequently, it is possible for a viewer to view a single event from different vantage points, However, in each instance of the prior art, a viewer must watch a video segment from the perspective of the video capture device, and cannot switch between views in a synchronized fashion during video replay.

Consequently, alternative ways of viewing captured image data that allow for greater control by a viewer are desirable.

### SUMMARY OF THE INVENTION

Accordingly, the present invention provides methods and apparatus for capturing image data via high definition and 360° image capture devices strategically placed at multiple image capture points and making the image data available across a distributed platform in a synchronized manner. An operator may combine captured image data and synchronized audio streams into a viewing experience. Alternatively a user interface may be made available to allow a user to interactively create their own viewing experience of 360D and HD imagery synchronized with captured audio data.

The image data captured from multiple vantage points may be captured as one or both of: two dimensional image data or three dimensional image data. The data is synchronized such that a user may view image data from multiple vantage points, each vantage point being associated with a disparate image capture device. The data is synchronized such that the user may view image data of an event or subject at an instance in time, or during a specific time sequence, from one or more vantage points.

In some embodiments, a user may view multiple image capture sequences at once on a multi view interface pane. In additional embodiments, a user may sequentially choose one or multiple vantage points at a time. In still other embodiments, a user may view a sequence of video image data segments compiled by another user or “user producer,” such that the artistic preferences of amateur or professional users may be shared with other users.

Still further embodiments allow for multiple segments of image data to be combined with one or more of: unassociated images, unassociated video segments and editorial content to generate a hybrid of event imagery and external imagery.

One general aspect includes apparatus for providing a switchable multiple video track platform, the apparatus including: a plurality of arrays of image capture devices deployed at a plurality of vantage points in relation to an event subject location; one or more high definition image capture devices deployed in at least one vantage points in relation to the event subject location; one or more audio capture device deployed in at least one audio vantage point in relation to the event subject location; a multiplexer configured to. The apparatus may also receive input including image data from the plurality of arrays of image capture devices and the one or more high definition image capture devices and at least one audio feed from the one or more audio capture device. The apparatus also includes synchronize and encode the input to produce an encoded and synchronized output. The apparatus also includes a content delivery network for transmitting the encoded and synchronized output.

Implementations may include one or more of the following features: The apparatus wherein the at least one vantage point allows the one or more high definition image capture devices to capture a primary view of an event subject. The apparatus wherein at least one of the plurality of arrays of image capture devices captures a 360° view from at least one of the plurality of vantage points. The apparatus additionally including an apparatus for muxing image data captured by the plurality of image data devices and the one or more high definition image capture device, wherein the content delivery network transmits muxed. The apparatus additionally including an apparatus for muxing image data captured by the plurality of image data devices and the one or more high definition image capture device, wherein the content delivery network transmits muxed image data.

The apparatus may also include a satellite uplink for transmitting the muxed image data. The muxed image data may include a 360° view from at least one of the plurality of vantage points. The apparatus may transmit the encoded and synchronized output. The method may also include the method step of muxing one or both the image data and the high definition. The method may further include the method step of muxing one or both the image data and the high definition image data. The method may also include the method step of transmitting the muxed data. The method may further include the method step of transmitting the muxed image data. The method may also include the method where the muxed image data includes a 360° view from at least one of the plurality of vantage points.

One general aspect includes the apparatus where the muxed image data includes a 360° view from at least one of the plurality of vantage points. The method of providing a switchable multiple video track platform may include the method steps of capturing image data from a plurality of arrays of image capture devices deployed at a plurality of vantage points in relation to an event subject location; capturing high definition image data from one or more high definition image capture devices deployed in at least one vantage points in relation to the event subject location; capturing audio data from one or more audio capture device deployed in at least one audio vantage point in relation to the event subject location; synchronizing and encoding captured data to produce an encoded and synchronized output, where the captured data includes image data from the plurality of arrays of image capture devices and the one or more high definition image capture devices and at least one audio feed from the one or more audio capture device; and transmitting the encoded and synchronized output.

Implementations may include one or more of the following features: The method step of transmitting the encoded and synchronized output. The method may also include the method step of muxing one or both the image data and the high definition. The method may further include the method step of muxing one or both the image data and the high definition image data. The method may also include the method step of transmitting the muxed data. The method may further include the method step of transmitting the muxed image data. The method may also include the method where the muxed image data includes a 360° view from at least one of the plurality of vantage points.

### BRIEF DESCRIPTION OF THE DRAWINGS

The accompanying drawings, that are incorporated in and constitute a part of this specification, illustrate several embodiments of the invention and, together with the description, serve to explain the principles of the invention:

FIG. 1 illustrates a block diagram of apparatus and functions from raw camera feeds and audio feeds to muxed input to a Content Data Network.

FIG. 2 illustrates a block diagram of apparatus and functions from muxed data feeds and audio feeds to muxed input to a live emulation player.

FIG. 3 illustrates a block diagram of apparatus and functions from decoders to media delivery.

FIG. 4 illustrates apparatus that may be used to implement those aspects of the present invention involving executable software.

### DETAILED DESCRIPTION

The present invention provides generally for a User-Controllable platform for processing multiple video tracks. In some embodiments, the platform may be Server-Based. Additionally, some embodiments may be processed in a Real Time Switchable mode, wherein “Real Time” refers to a system with no artificial delays introduced.

As presented and discussed below, a workflow may include processes by which muxed video and audio package is ingested into a content delivery network, transcoded, segmented and indexed for use in a multiple video track platform with synchronized audio. Indices may be manipulated in real time to give a user the ability to seamlessly choose a camera angle of the user's choice using tools similar to those traditionally reserved for switching a bitrate of video files on the fly. Some embodiments may include creation of a default directors cut index file from the data Metadata tracks by passing editorial decisions to the server. The present invention provides generally for the use of multiple camera arrays for the capture and processing of image data that may be used to generate visualizations of live performance imagery from a multi-perspective reference. More specifically, the visualizations of the live performance imagery can include oblique and/or orthogonal approaching and departing view perspectives for a performance setting. Image data captured via the multiple camera arrays is synchronized and made available to a user via a communications network. The user may choose a viewing vantage point from the multiple camera arrays for a particular instance of time or time segment.

In the following sections, detailed descriptions of embodiments and methods of the invention will be given. The description of both preferred and alternative embodiments though through are exemplary only, and it is understood that to those skilled in the art that variations, modifications and alterations may be apparent. It is therefore to be understood that the exemplary embodiments do not limit the broadness of the aspects of the underlying invention as defined by the claims.

Definitions

As used herein, “Image Capture Device” refers to apparatus for capturing digital image data, an Image capture device may be one or both of: a two dimensional camera (sometimes referred to as “2D”) or a three dimensional camera (sometimes referred to as “3D”). In some exemplary embodiments an image capture device includes a charged coupled device (“CCD”) camera.

As used herein, Production Media Ingest refers to the collection of image data and input of image data into storage for processing, such as Transcoding and Caching. Production Media Ingest may also include the collection of associated data, such a time sequence, a direction of image capture, a viewing angle, 2D or 3D image data collection.

As used herein, Vantage Point refers to a location of Image Data Capture in relation to a stage or subject matter to be captured.

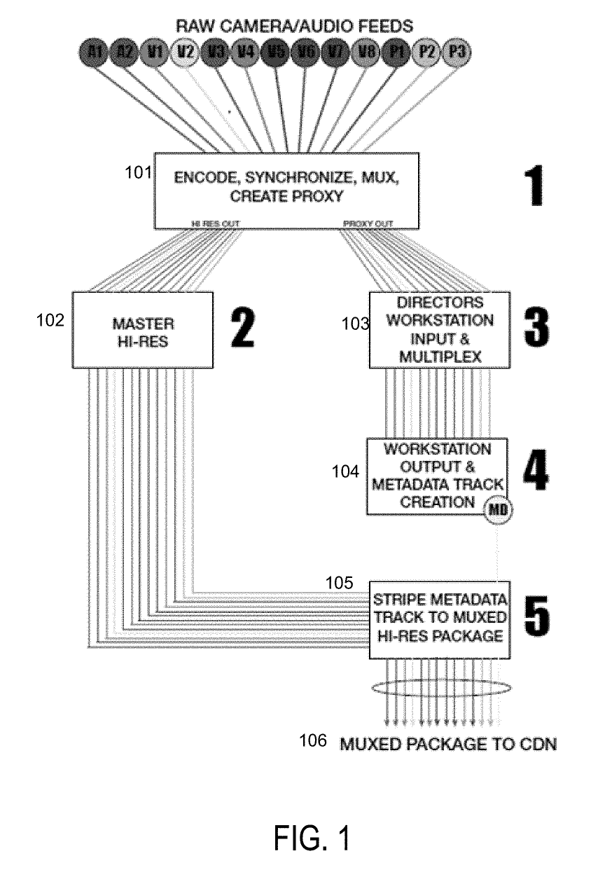

Referring now to FIG. 1, a workflow may include processes by which video or other image data is encoded and muxed on set into a high resolution on set into a high resolution and low resolution (proxy) stream. The image data may then be sent through a director's workstation where a series of editorial choices are embedded in a metadata track. The track may then synchronized with, and muxed on set, into a high resolution and low resolution (proxy) stream. It may also then be sent through the director's workstation where a series of editorial choices may be embedded in a metadata track. That track is then synchronized with and muxed into the high resolution stream, which may bypass the director's workstation.

At 101, various video and audio tracks may be ingested into an encoding workflow. Latency on 360 cameras (due to the stitching servers) may be accounted for at this stage. Audio tracks and video tracks may be encoded into a high res muxed package and a low-res proxy package (for use by the director's workstation). The two packages are then output to the mastering drives (high res) and directors' workstation (low res).

At 102, a high resolution package, including stitched 360 cameras, HD cameras and synchronized audio may be mastered to solid state hard drives for use in the post production workflow for on-demand content. They may be throughput for muxing with the metadata track at a later stage in the workflow.

At 103, a low resolution package may be ingested into the director's workstation where it is multiplexed into a workable user interface with which the director can make editorial decisions.

At 104, the director's workstation may allow a director to make editorial decisions for the live webcast, and passes further metadata regarding these choices to the player. Variables accessible by the director include which camera to cut to (line edit), which angle to be dynamically facing in the 360 player, and which level of zoom should be employed by the 360 player. As the director makes decisions, a currently desired camera angle may be captured and printed in the track. Further information to be passed to the player may include, for example, which format of video is being employed by the director (i.e. 360 vs. HD,) so the player can route the video to the correct sub-player. The metadata track may then encoded into a readable audio track, with synchronous time code, to be synchronized with and muxed into the high resolution package created in step 2.

At 105, an original high resolution package, throughput from the mastering phase, may then synchronized with the metadata track containing the director's decisions and relevant instructions for the player to reconstruct the director's decisions. It requires synchronization as the lag introduced in step 2 will almost certainly be not equal to the lag introduced in steps 3 and 4. Finally, it is striped back onto a muxed multiple video & audio track media package for uplink to the CDN.

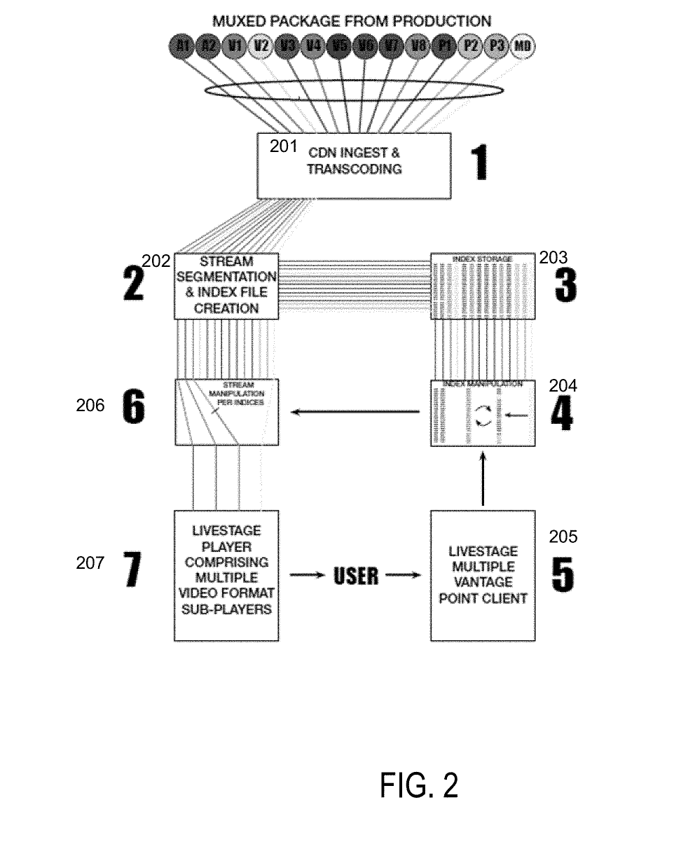

Referring now to FIG. 2, at 201, various audio, video and metadata tracks may be ingested into a Content Data Network system for transcoding. The tracks may be transcoded into multiple codecs and bitrates and then stored on the system. For the purposes of simplifying the remaining steps, each step from this point assumes the same bitrate and codec. However, alternative bitrate and codec formats are within the scope of the present invention.

At 202, each track may be segmented into multiple tiny parts in the same manner used for variable bitrate streaming. For the purposes of reassembly of the video track, one or more parts may be logged in an index file, unique to that track, used to replay the track as a synchronous whole. A maximum latency on a user dictated video track change may be directly attributable to a size of these segments; the segments may be as short as possible to facilitate a shortest latency. Other embodiments include various latencies.

At 203, index files for one or more tracks are then transferred to a Livestage Server, to which various video requests may be made by a player. At the time of initiating content, the player may download appropriate index files for each camera angle thereby instructing the player which segments are required to be downloaded from the Content Delivery Network in order to reassemble the each video into a coherent track.

At 204, a default index file may be created by referring to the metadata track created in the director's workstation. The metadata track contains the editorial decisions made by the director at the time of production. Camera changes may then be translated into a hybrid index file comprised of segments from all the camera angles/video tracks. The user may elect to dynamically manipulate a default index file by making the user's own camera angle change requests (i.e. switch cameras), or restore a director's cut by reverting to an original hybrid index file. A blue track may be selected to replace a green track after a next segment (or fraction thereof) amounting to less than a second.

At 205, a user is able to select a default hybrid index file (directors cut) or dynamically make changes to an index file by requesting that other cameras indices replace next segments in the default index. In exemplary cases the user may be considered to have selected the blue camera next.

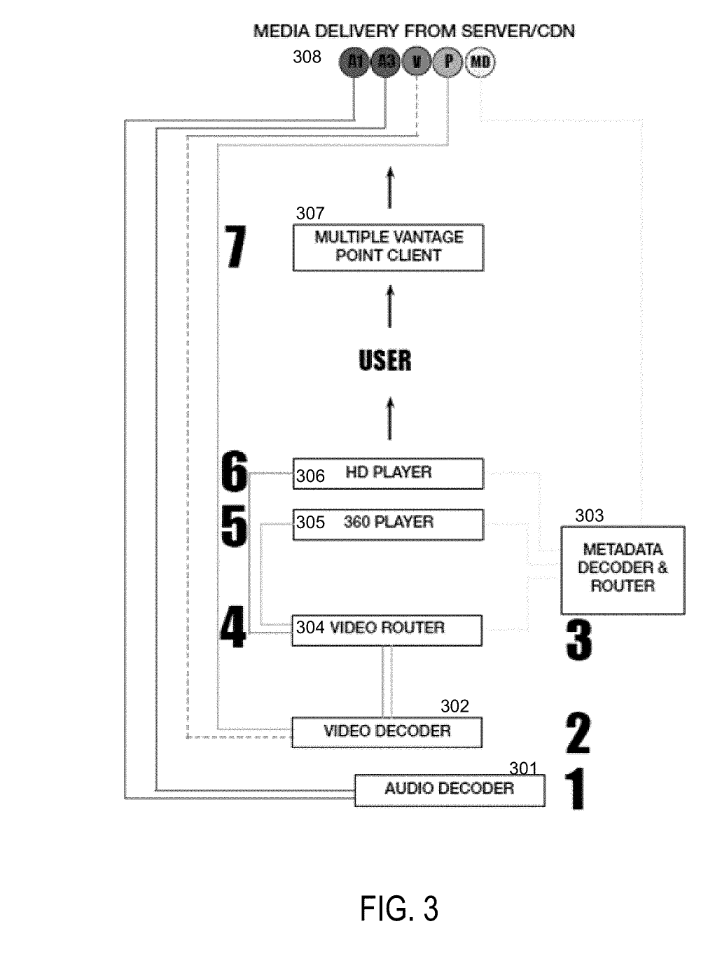

Referring now to FIG. 3, a workflow may include processes by which alternating forms of video content are decoded and routed to the correct layer/sub-layer of the Livestage video player. The metadata track is read both to convey the director's editorial choices, and the technical requirements of each frame of video. As each frame is decoded, its metadata track is read to determine whether it is a 360 frame of video or an HD frame of video. Instructions are then sent to the relevant elements of the player in order to playback the media. All video and metadata tracks are slave to the audio track, prioritizing the audio for flawless playback.

At 301, audio tracks are read by the player (2 tracks for stereo, 5.1/7/.1 tracks for Dolby, and relayed to the local audio device.

At 302, current video track may be relayed to the video decoder. For the purposes of the diagram, both an HD and a 360 video track are demonstrated. The green track represents the current 360 video. The blue track represents the next selected video in the previous document which is currently inactive.

At 303, as video and audio are decoded, one or both of information received from the director, and the technical requirements of each frame, are decoded by the metadata decoder. Information regarding which format of video is being employed is passed to all of the video router, the HD player and the 360 player to inform them to behave accordingly. The editorial decisions within the 360 player are passed to the 360 player.

At 304, the video router reads the instructions regarding which format of video it is currently decoding and passes the current frame to the relevant player (either 360 or HD). To those skilled in the art, it may b obvious that the usefulness of this procedure is not limited to the intercutting of 360 and HD, but rather this may be used in many environments where multiple formats of media are being intercut into a coherent visual experience.

At 305, the 360 player, such as those referred to as the KingPlaya™ player, receives the decoded frames and displays them in its proprietary 360 player configuration. When the 360 player is not in use, it is hidden or deactivated. Information regarding when to show and hide the player is received from the technical elements of the metadata track.

At 306, a HD player receives the decoded frames and displays them in a traditional HD player layer on top of the 360 player. When not in use the HD player is hidden. Information regarding when to show and hide the player is received from the technical elements of the metadata track.

At 307, as the user consumes the video content, choices regarding which camera angle to view are relayed to the server through the configuration detailed in the document outlining the Server-based, user-controllable, real-time-switchable multiple video track platform.

The teachings of the present invention may be implemented with apparatus capable of embodying the innovative concepts described herein. Image presentation can be accomplished via multimedia type user interface. Embodiments can therefore include a personal computer, handheld, game controller; PDA, cellular device, smart device, High Definition Television or other multimedia device with user interactive controls, including, in some embodiments, voice activated interactive controls.

Apparatus

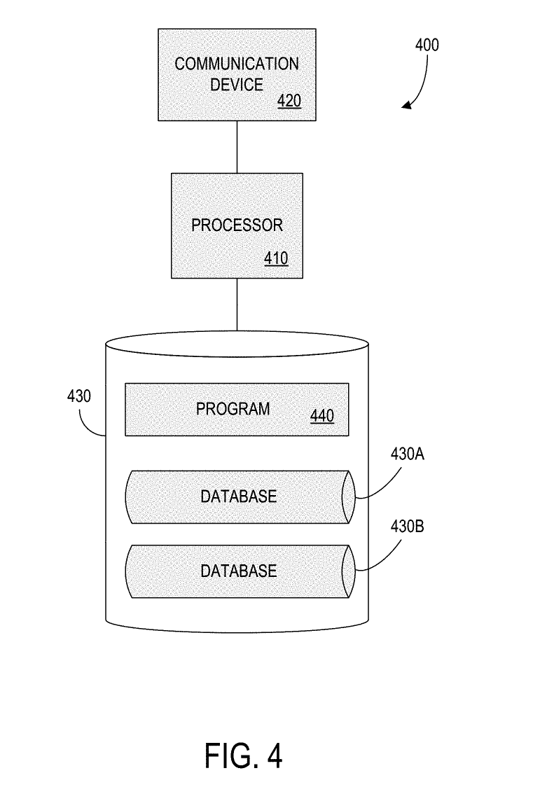

In addition, FIG. 4 illustrates a controller 400 that may be utilized to implement some embodiments of the present invention. The controller may be included in one or more of the apparatus described above, such as the Revolver Server, and the Network Access Device. The controller 400 comprises a processor unit 410, such as one or more semiconductor based processors, coupled to a communication device 420 configured to communicate via a communication network (not shown in FIG. 4). The communication device 420 may be used to communicate, for example, with one or more online devices, such as a personal computer, laptop or a handheld device.

The processor 410 is also in communication with a storage device 430. The storage device 430 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 430 can store a software program 440 for controlling the processor 410. The processor 410 performs instructions of the software program 440, and thereby operates in accordance with the present invention. The processor 410 may also cause the communication device 420 to transmit information, including, in some instances, control commands to operate apparatus to implement the processes described above. The storage device 430 can additionally store related data in a database 430A and database 430B, as needed.

Apparatus described herein may be included, for example in one or more smart devices such as, for example: a mobile phone, tablet or traditional computer such as laptop or microcomputer or an Internet ready TV.

The above described platform may be used to implement various features and systems available to users. For example, in some embodiments, a user will provide all or most navigation. Software, which is executable upon demand, may be used in conjunction with a processor to provide seamless navigation of 360/3D/panoramic video footage with Directional Audio—switching between multiple 360/3D/panoramic cameras and user will be able to experience a continuous audio and video experience.

Additional embodiments may include the system described automatic predetermined navigation amongst multiple 360/3D/panoramic cameras. Navigation may be automatic to the end user but the experience either controlled by the director or producer or some other designated staff based on their own judgment.

Still other embodiments allow a user to record a user defined sequence of image an audio content with navigation of 360/3D/panoramic video footage, Directional Audio, switching between multiple 360/3D/panoramic cameras. In some embodiments, user defined recordations may include audio, text or image data overlays. A user may thereby act as a producer with the Multi-Vantage point data, including directional video and audio data and record a User Produced multimedia segment of a performance. The User Produced may be made available via a distributed network, such as the Internet for viewers to view, and, in some embodiments further edit the multimedia segments themselves.

In some embodiments a User may have manual control in auto mode. The User is able to manually control by actions such as swipe or equivalent to switch between MVPs or between HD and 360

In some additional embodiments, an Auto launch Mobile Remote App may launch as soon as video is transferred from iPad to TV using Apple Airplay. Using tools, such as, for example, Apple's Airplay technology, a user may stream a video feed from iPad or iPhone to a TV is connected to Apple TV. When a user moves the video stream to TV, automatically mobile remote application launches on iPad or iPhone is connected/synched to the system. Computer Systems may be used to displays video streams and switches seamlessly between 360/3D/Panoramic videos and High Definition (HD) videos.

In some embodiments that implement Manual control, executable software allows a user to switch between 360/3D/Panoramic video and High Definition (HD) video without interruptions to a viewing experience of the user. The user is able to switch between HD and any of the multiple vantage points coming as part of the panoramic video footage.

In some embodiments that implement Automatic control a computer implemented method (software) that allows its users to experience seamlessly navigation between 360/3D/Panoramic video and HD video. Navigation is either controlled a producer or director or a trained technician based on their own judgment.

Manual Control and Manual Control systems may be run on a portal computer such as a mobile phone, tablet or traditional computer such as laptop or microcomputer. In various embodiments, functionality may include: Panoramic Video Interactivity, Tag human and inanimate objects in panoramic video footage; interactivity for the user in tagging humans as well as inanimate objects; sharing of these tags in real time with other friends or followers in your social network/social graph; Panoramic Image Slices to provide the ability to slice images/photos out of Panoramic videos; real time processing that allows users to slice images of any size from panoramic video footage over a computer; allowing users to purchase objects or items of interest in an interactive panoramic video footage; ability to share panoramic images slides from panoramic videos via email, sms (smart message service) or through social networks; share or send panoramic images to other users of a similar application or via the use of SMS, email, and social network sharing; ability to “tag” human and inanimate objects within Panoramic Image slices; real time “tagging” of human and inanimate objects in the panoramic image; allowing users to purchase objects or items of interest in an interactive panoramic video footage; content and commerce layer on top of the video footage—that recognizes objects that are already tagged for purchase or adding to user's wish list; ability to compare footage from various camera sources in real time; real time comparison panoramic video footage from multiple cameras captured by multiple users or otherwise to identify the best footage based on aspects such as visual clarity, audio clarity, lighting, focus and other details; recognition of unique users based on the user's devices that are used for capturing the video footage (brand, model #, MAC address, IP address, etc); radar navigation of which camera footage is being displayed on the screens amongst many other sources of camera feeds; navigation matrix of panoramic video viewports that in a particular geographic location or venue; user generated content that can be embedded on top of the panoramic video that maps exactly to the time codes of video feeds; time code mapping done between production quality video feed and user generated video feeds; user interactivity with the ability to remotely vote for a song or an act/song while watching a panoramic video and effect outcome at venue. Software allows for interactivity on the user front and also ability to aggregate the feedback in a backend platform that is accessible by individuals who can act on the interactive data; ability to offer “bidding” capability to panoramic video audience over a computer network, bidding will have aspects of gamification wherein results may be based on multiple user participation (triggers based on conditions such # of bids, type of bids, timing); Heads Up Display (HUD) with a display that identifies animate and inanimate objects in the live video feed wherein identification may be tracked at an end server and associated data made available to frontend clients.

Conclusion

A number of embodiments of the present invention have been described. While this specification contains many specific implementation details, there should not be construed as limitations on the scope of any inventions or of what may be claimed, but rather as descriptions of features specific to particular embodiments of the present invention.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed invention.

What is claimed is:

1. Apparatus for providing a switchable multiple video track platform, the apparatus comprising:
a plurality of arrays of image capture devices deployed at a plurality of vantage points in relation to an event subject location, each array of image capture devices capable of simultaneous recording of image data in a 360 degree view;
a high definition image capture devices deployed at a vantage point in relation to the event subject location;
one or more audio capture device deployed in at least one audio vantage point in relation to the event subject location;
a multiplexer configured to:
receive input comprising image data frames from the plurality of arrays of image capture devices and the one or more high definition image capture devices;
index the image data frames from each of the plurality of arrays and the one or more high definition image capture devices, said index correlating multiple respective image data frames with respective instances in time;
index audio data captured from at least one audio feed from the one or more audio capture devices, said index correlating with the respective instances in time; and
synchronize the image data frames in segments associated with an instance in time and encode the image data frames to produce an encoded and synchronized output viewable by a user according to multiple instances in time; and
a content delivery network for transmitting the encoded and synchronized output that allows a remote user to view image data in segments associated with different instances of time from different vantage points and different viewing directions at a user's discretion.

2. The apparatus of claim 1, wherein the at least one vantage point allows the one or more high definition image capture devices to capture a primary view of an event subject.

3. The apparatus of claim 1, wherein at least one of the plurality of arrays of image capture devices captures a 360° view from at least one of the plurality of vantage points.

4. The apparatus of claim 1 additionally comprising an apparatus for muxing image data captured by the plurality of image data devices and the one or more high definition image capture device, wherein the content delivery network transmits muxed image data.

5. The apparatus of claim 4 additionally comprising a satellite uplink for transmitting the muxed image data.

6. The apparatus of claim 4, wherein the muxed image data comprises a 360° view from at least one of the plurality of vantage points.

7. A method of providing a switchable multiple video track platform, the method comprising:
capturing image data from a plurality of arrays of image capture devices deployed at a plurality of image data vantage points in relation to an event subject location, each array of image capture devices capable of simultaneous recording of image data in a 360 degree view;
capturing high definition image data from one or more high definition image capture devices deployed in at least one vantage point in relation to the event subject location;
capturing audio data from one or more audio capture device deployed in at least one audio vantage point in relation to the event subject location;
synchronizing the image data in segments associated with respective instances of time;
encoding the image data in segments associated with an instance of time to produce an encoded and synchronized image data associated with an instance in time, wherein the image data in segments associated with an instance of time comprises image data from the plurality of arrays of image capture devices and the one or more high definition image capture devices;
synchronizing audio data captured from the one or more audio capture devices to associated segments of audio data and the respective instances in time; and
transmitting the encoded and synchronized image data associated with an instance in time and associated segments of audio data with the respective instances in time to a user according to the user's choice of vantage point for a given instance of time.

8. The method of claim 7, further comprising the method step of muxing one or both the image data and the high definition image data.

9. The method of claim 8, further comprising the method step of transmitting the muxed image data.

10. The method of claim 8, wherein the muxed image data comprises a 360° view from at least one of the plurality of vantage points.
